(19) United States
(12) Patent Application Publication
(10) Pub. No.: US 2024/0400865 A1
(43) Pub. Date: Dec. 5, 2024

(54) PHOTOPOLYMERIZABLE COMPOSITION, METHODS OF BONDING AND SEALING, AND AT LEAST PARTIALLY POLYMERIZED COMPOSITION

(71) Applicant: 3M INNOVATIVE PROPERTIES COMPANY, St. Paul, MN (US)

(72) Inventors: Amanda K. Leone, St. Paul, MN (US); Bryan T. Whiting, St. Paul, MN (US); Kai U. Claussen, Duesseldorf (DE); William H. Moser, Edina, MN (US)

(21) Appl. No.: 18/698,451

(22) PCT Filed: Aug. 18, 2022
(86) PCT No.: PCT/IB2022/057758

§ 371 Date: Apr. 4, 2024

Related U.S. Application Data
(60) Provisional application No. 63/272,781, filed on Oct. 28, 2021.

(51) Int. Cl. C09J 4/00; B32B 37/12; C08F 220/18; C08F 220/28; C09J 5/00; C09J 133/08; C09J 133/14

(52) U.S. Cl. CPC C09J 4/00; B32B 37/12; C08F 220/1808; C08F 220/281; C09J 5/00; C09J 133/08; C09J 133/14; B32B 2037/1253; C09J 2433/00

(57) ABSTRACT

A photopolymerizable composition comprises at least one free-radically polymerizable compound; at least one organic photoactivatable reducing agent precursor; at least one reducible transition metal compound comprising at least one of cobalt, copper, iron, manganese, nickel, or vanadium; at least one organic peroxide; and at least one photoinitiator. The at least one photoinitiator does not comprise an organic peroxide. Methods of bonding and sealing, and an at least partially polymerized composition are also disclosed.

### BACKGROUND

Free-radically photopolymerizable systems can provide precise control of polymerization by the application of actinic radiation (e.g., ultraviolet light). The requirement of continued application of light for sustained reaction can be an advantage in some cases, but a constraint in others; for example, i) when polymerization must take place in areas inaccessible to actinic radiation, ii) when rapid assembly is required for manufacturing, and/or iii) a high degree of monomer conversion is required to meet regulatory requirements and/or reach the material's desired properties.

Alternatively, redox free-radical polymerization is a prominent and industrially relevant chemical technique for rapidly generating polymers at ambient conditions. Redox radical polymerization systems generally include a free-radically polymerizable compound, an oxidizing agent, and a reducing agent. The oxidizing and reducing agents are selected to react with one another to generate free-radical species, which can initiate a radical-mediated reaction of monomers to form polymers. The oxidizing and reducing agents are commonly stored on separate sides of a 2-part composition, giving users the ability to mix the parts and produce polymer when desired. This rapid curing upon mixing can be a limitation during manufacturing because the reactivity can be difficult to control.

### SUMMARY

Photopolymerizable compositions and methods according to the present disclosure provide advantages over prior compositions and methods in that they circumvent challenges associated with traditional redox-initiated systems and light cured systems. For example, photopolymerizable compositions according to the present disclosure contain reducing agents with reduced or latent activity during storage and delivery of the photopolymerizable composition. An external stimulus generates a more reactive reductant (or oxidant), triggering a redox free-radical cure. The time between adhesive delivery and external stimulus can be tuned depending on manufacturing process requirements. As such, photopolymerizable compositions according to the present disclosure can improve manufacturing flexibility, especially for bonding opaque substrates.

Photopolymerizable compositions and methods according to the present disclosure are particularly advantageous in processes using low viscosity adhesive fluids such as, for example, those necessary for piezo inkjet dispensing and valve jet dispensing. For example, lower viscosity free-radically polymerizable compositions are typically more affected by oxygen inhibition resulting from rapid oxygen diffusion than higher viscosity ones. Initial curing caused by the decomposition of the photoinitiator results in increased viscosity which reduces oxygen sensitivity of the redox cure, which may lead to lead to improved cohesive strength and static shear strength.

In one aspect, the present disclosure provides a photopolymerizable composition comprising:
at least one free-radically polymerizable compound;
at least one organic photoactivatable reducing agent precursor;
at least one reducible transition metal compound comprising at least one of cobalt, copper, iron, manganese, nickel, or vanadium;
at least one organic peroxide; and
at least one photoinitiator, wherein the at least one photoinitiator does not comprise an organic peroxide.

In one embodiment, the photopolymerizable composition is divided into a Part A portion and a Part B portion, wherein none of the at least one reducible transition metal compound is present in Part A, and wherein none of the at least one organic peroxide is present in Part B.

In one embodiment, the photopolymerizable composition is divided into a Part A portion and a Part B portion, wherein none of the at least one tertiary or quaternary ammonium salt is present in Part A, and wherein none of the at least one organic peroxide is present in Part B.

In another aspect, the present disclosure provides method of bonding first and second substrates, the method comprising contacting the photopolymerizable composition according to the present disclosure with a first substrate, then exposing at least a portion of the photopolymerizable composition to actinic radiation sufficient to cause partial curing of the photopolymerizable composition, and then contacting at least a portion of the partially cured photopolymerizable composition with the second substrate.

In one embodiment, the present disclosure provides method of bonding first and second substrates, the method comprising disposing the photopolymerizable composition according to the present disclosure between a first and second substrate, then exposing at least a portion of the photopolymerizable composition to actinic radiation sufficient to cause partial curing of the photopolymerizable composition.

In another aspect, the present disclosure provides a method of sealing a substrate, the method comprising contacting the photopolymerizable composition according to the present disclosure with the substrate, exposing the photopolymerizable composition to actinic radiation, and at least partially curing the photopolymerizable composition.

In yet another aspect, the present disclosure provides a polymerized composition comprising an at least partially cured photopolymerizable composition (e.g., a pressure-sensitive adhesive) according to the present disclosure.

As used herein,
the prefix “(meth)acryl” refers to “methacryl” and/or “acryl”;
the term “pressure sensitive adhesive” refers to a composition possessing properties including the following: (1) aggressive and permanent tack at room temperature, (2) adherence with no more than finger pressure, (3) sufficient ability to hold onto an adherend, and (4) sufficient cohesive strength to be cleanly removable from the adherend.

Features and advantages of the present disclosure will be further understood upon consideration of the detailed description as well as the appended claims.

### DETAILED DESCRIPTION

Photopolymerizable compositions according to the present disclosure comprise at least one free-radically polymerizable compound. Any free-radically polymerizable compound(s) may be used. Examples of free-radically polymerizable compounds include (meth)acrylates, (meth)acrylamides, vinyl ethers (e.g., methyl vinyl ether and ethyl vinyl ether), vinyl esters (e.g., vinyl acetate and vinyl propionate), vinyl halides, styrene and substituted styrenes (e.g., α-methylstyrene and divinylstyrene), N-vinylamides (e.g., N-vinylformamide, N-vinylacetamide, and also including N-vinyl lactams such as N-vinylpyrrolidone and N-vinylcaprolactam), maleimides, and allyl and/or vinyl compounds (e.g., allylic alkenes, (e.g., propene, isomers of butene, pentene, hexene up to dodecene, isoprene, and butadiene)), and combinations thereof. The free-radically polymerizable compound(s) may have one or more (e.g., two, three, four, five, six, or more) free-radically polymerizable groups, which may be of the same or different types. To ensure chemical crosslinking, usually at least some of the free-radically polymerizable compound(s) have two or more free-radically polymerizable groups.

Examples of suitable (meth)acrylates and (meth)acrylamides include mono-, di-, and poly-(meth)acrylates and (meth)acrylamides such as, for example, 1,2,4-butanetriol tri(meth)acrylate, 1,3-butylene glycol di(meth)acrylate, 1,3-propanediol di(meth)acrylate, 1,4-butanediol di(meth)acrylate, 1,4-cyclohexanediol di(meth)acrylate, 1,6-hexanediol di(meth)acrylate, 1,6-hexanediol monomethacrylate monoacrylate, 2-phenoxyethyl (meth)acrylate, alkoxylated cyclohexanedimethanol di(meth)acrylates, alkoxylated hexanediol di(meth)acrylate, alkoxylated neopentyl glycol di(meth)acrylate, allyl (meth)acrylate, bis[1-(2(meth)acryloxy)]-p-ethoxyphenyldimethylmethane, bis[1-(3-(meth)acryloxy-2-hydroxy)]-p-propoxyphenyldimethylmethane, caprolactone-modified dipentaerythritol hexa(meth)acrylate, caprolactone modified neopentyl glycol hydroxypivalate di(meth)acrylate, cyclohexanedimethanol di(meth)acrylate, diethylene glycol di(meth)acrylate, dipentaerythritol penta(meth)acrylate, dipropylene glycol di(meth)acrylate, ditrimethylolpropane tetra(meth)acrylate, ethoxylated (10) bisphenol A di(meth)acrylate, ethoxylated (20) trimethylolpropane tri(meth)acrylate, ethoxylated (3) bisphenol A di(meth)acrylate, ethoxylated (3) trimethylolpropane tri(meth)acrylate, ethoxylated (30) bisphenol A di(meth)acrylate, ethoxylated (4) bisphenol A di(meth)acrylate, ethoxylated (4) pentaerythritol tetra(meth)acrylate, ethoxylated (6) trimethylolpropane tri(meth)acrylate, ethoxylated (9) trimethylolpropane tri(meth)acrylate, ethoxylated bisphenol A di(meth)acrylate, ethyl (meth)acrylate, ethylene glycol di(meth)acrylate, 2-ethylhexyl (meth)acrylate, glycerol tri(meth)acrylate, hydroxypivalaldehyde-modified trimethylolpropane di(meth)acrylate, octyl (meth)acrylate, nonyl (meth)acrylate, decyl (meth)acrylate, lauryl (meth)acrylate, tridecyl (meth)acrylate, isobornyl (meth)acrylate, isopropyl (meth)acrylate, methyl (meth)acrylate, neopentyl glycol di(meth)acrylate, n-hexyl (meth)acrylate, pentaerythritol tetra(meth)acrylate, pentaerythritol tri(meth)acrylate, polyethylene glycol (200) di(meth)acrylate, polyethylene glycol (400) di(meth)acrylate, polyethylene glycol (600) di(meth)acrylate, propoxylated (3) glyceryl tri(meth)acrylate, propoxylated (3) trimethylolpropane tri(meth)acrylate, propoxylated (5.5) glyceryl tri(meth)acrylate, propoxylated (6) trimethylolpropane tri(meth)acrylate), propoxylated neopentyl glycol di(meth)acrylate, sorbitol hexa(meth)acrylate, stearyl (meth)acrylate, tetraethylene glycol di(meth)acrylate, tetrahydrofurfuryl (meth)acrylate, tricyclodecanedimethanol di(meth)acrylate, triethylene glycol di(meth)acrylate, trimethylolpropane tri(meth)acrylate, tripropylene glycol di(meth)acrylate, tris(2-hydroxyethyl) isocyanurate tri(meth)acrylate, (meth)acrylamide, N,N-dimethylacrylamide, N-vinylpyrrolidone, N-vinylcaprolactam, methylene bis (meth)acrylamide, diacetone (meth)acrylamide, (meth)acryloylmorpholine, urethane (meth)acrylates, polyester (meth)acrylates, epoxy (meth)acrylates, copolymerizable mixtures of (meth)acrylated monomers such as those in U.S. Pat. No. 4,652,274 (Boettcher et al.), (meth)acrylated oligomers such as those of U.S. Pat. No. 4,642,126 (Zador et al.), poly(ethylenically-unsaturated) carbamoyl isocyanurates such as those disclosed in U.S. Pat. No. 4,648,843 (Mitra), and combinations thereof.

Suitable urethane (meth)acrylate oligomer(s) may include aromatic urethane acrylates, aliphatic urethane acrylates, aromatic/aliphatic urethane acrylates and combinations thereof. Many urethane (meth)acrylate oligomer(s) are available commercially. Suitable examples of urethane (meth)acrylate oligomer(s) may be obtained from Arkema, King of Prussia, Pennsylvania, and marketed as CN1964 (aliphatic urethane dimethacrylate), CN1968 (low viscosity urethane methacrylate oligomer), CN310 (urethane acrylate oligomer), CN996 (aromatic polyester-based urethane diacrylate oligomer); SOLTECH LTD., Yangsan, South Korea, and marketed as SUA5371 (difunctional aliphatic urethane acrylate oligomer); Nippon Soda Co. Ltd., Chiyoda, Japan, and marketed as 1E-2000 (polybutadiene urethane methacrylate), TEAI-1000 (polybutadiene urethane acrylate); Dymax, Torrington, Connecticut, and marketed as BR-3747AE (aliphatic polyether urethane acrylate), BRC-843 S (hydrophobic urethane acrylate), BR640D (polybutadiene urethane acrylate), and combinations thereof. Other suitable urethane (meth)acrylate oligomer(s) may be prepared by the reaction of (i) a polyisocyanate and a hydroxy-functional (meth)acrylate, and/or (ii) a polyisocyanate, a polyol, and a hydroxy-functional (meth)acrylate. In some examples, the urethane (meth)acrylate is a reaction product of one or more polyisocyanate(s), one or more polyol(s), and one or more hydroxy-functional (meth)acrylate(s).

Other suitable (meth)acrylates include siloxane-functional (meth)acrylates as disclosed, for example, in PCT Published Application Nos. WO 00/38619 (Guggenberger et al.), WO 01/92271 (Weinmann et al.), WO 01/07444 (Guggenberger et al.), and WO 00/42092 (Guggenberger et al.) and fluoropolymer-functional (meth)acrylates as disclosed in, for example, U.S. Pat. No. 5,076,844 (Fock et al.), U.S. Pat. No. 4,356,296 (Griffith et al.), EP 0 373 384 (Wagenknecht et al.), EP 0 201 031 (Reiners et al.), and EP 0 201 778 (Reiners et al.).

Suitable free-radically polymerizable compounds may contain hydroxyl groups and free-radically polymerizable functional groups in a single molecule. Examples of such materials include hydroxyalkyl (meth)acrylates such as 2-hydroxyethyl (meth)acrylate; 4-hydroxybutyrate; poly(propylene glycol) (meth)acrylate; 2-hydroxypropyl (meth)acrylate; glycerol mono- or di-(meth)acrylate; trimethylolpropane mono- or di-(meth)acrylate; pentaerythritol mono-, di-, and tri-(meth)acrylate; sorbitol mono-, di-, tri-, tetra-, or penta(meth)acrylate; and 2,2-bis[4-(2-hydroxy-3-methacryloxypropoxy)phenyl]propane (bisGMA).

(Meth)acrylated oligomers and polymers may also be used. Examples include polyester (meth)acrylates, polyurethane (meth)acrylates, and (meth)acrylated epoxy (meth)acrylates. (Meth)acrylated epoxy (meth)acrylates and polyester (meth)acrylates are most preferred because they tend to have a relatively low viscosity and therefore allow a more uniform layer to be applied by the spin coating method. Specifically, preferred multifunctional (meth)acrylate oligomers include those commercially available from Allnex, Frankfurt, Germany and marketed under the trade name EBECRYL. Examples include EBECRYL 40 (tetrafunctional acrylated polyester oligomer), EBECRYL 80 (low viscosity amine-modified multifunctional acrylated polyether oligomer) EBECRYL 81 (multifunctional (meth)acrylated polyester oligomer), EBECRYL 600 (bisphenol A epoxy di(meth)acrylate), EBECRYL 605 (bisphenol A epoxy di(meth)acrylate diluted with 25% tripropylene glycol di(meth)acrylate), EBECRYL 3500 (difunctional Bisphenol A oligomer acrylate), EBECRYL 3604 (multifunctional polyester oligomer acrylate), EBECRYL 8301-R (hexafunctional aliphatic urethane acrylate), and combinations thereof.

In some embodiments, the at least one free-radically polymerizable compound comprises 0.01 to 40 weight percent, 0.1 to 35 weight percent, or even 5 to 30 weight percent of at least one compound having at least two (meth)acrylate groups.

The free-radically polymerizable composition may comprise an acid-functional monomer, where the acid-functional group may be an acid per se, such as a carboxylic acid, or a portion may be a salt thereof, such as an alkali metal carboxylate. Useful acid functional monomers include, but are not limited to, those selected from ethylenically unsaturated carboxylic acids, ethylenically unsaturated sulfonic acids, ethylenically unsaturated phosphoric or phosphoric acids, and mixtures thereof.

Examples of such compounds include those selected from acrylic acid, methacrylic acid, itaconic acid, fumaric acid, crotonic acid, citraconic acid, maleic acid, oleic acid, β-carboxyethyl (meth)acrylate, 2-sulfoethyl methacrylate, styrene sulfonic acid, 2-acrylamido-2-methylpropanesulfonic acid, vinylphosphonic acid, and mixtures thereof.

Due to their availability, acid functional monomers of the acid functional copolymer are generally selected from ethylenically unsaturated carboxylic acids, e.g., (meth)acrylic acids. When even stronger acids are desired, acidic monomers include the ethylenically unsaturated sulfonic acids and ethylenically unsaturated phosphoric acids. The acid functional monomer is generally used in amounts of 0.5 to 15 parts by weight, preferably 1 to 15 parts by weight, most preferably 5 to 10 parts by weight, based on 100 parts by weight total monomer.

Suitable free-radically polymerizable compounds are available from a wide variety of commercial sources such as, for example, Sartomer Co., Exton, Pennsylvania and/or can be made by known methods.

Typically, the polymerizable component(s) is/are present in the free-radically polymerizable composition in an amount of 10 to 99 weight percent, preferably 30 to 97 weight percent, and more preferably 50 to 95 weight percent, based on the total weight of the free-radically polymerizable composition, although other amounts may also be used.

Photopolymerizable compositions according to the present disclosure further comprise at least one organic photoactivatable reducing agent precursor. Photoactivatable reducing agent precursors useful in practice of the present disclosure generally have at least one (often only one) photoremovable group that is cleaved off by exposure to actinic radiation to form a reducing agent that can participate in a redox free-radical initiator system as described in the present disclosure.

Upon exposure to actinic radiation, R^{photo} of the organic photoactivatable reducing agent(s) precursor is/are cleaved off and the resulting reducing agent(s) participate in a redox cycle with the organic peroxide(s), and reducible transition metal compound(s) to generate free radicals that can initiate free radical polymerization.

Exemplary reducing agents include 1,3-dicarbonyl compounds such as, for example, barbituric acid and substituted derivatives thereof 3,4-dihydroxyfuran-2 (5H)-one and substituted derivatives thereof (e.g., 5-(1,2-dihydroxyethyl)-3,4-dihydroxyfumn-2 (5H)-one).

In some embodiments, at least one photoactivatable reducing agent precursor is represented by the formula

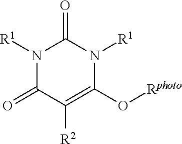

Each R¹ independently represents a hydrocarbyl group having from 1 to 18 carbon atoms, typically 1 to 8 carbon atoms, and often 1 to 4 carbon atoms. Examples include methyl, ethyl, propyl, butyl, hexyl, octyl, dodecyl, octadecyl, and phenyl.

R² represents a monovalent organic group having from 1 to 18 carbon atoms, typically 1 to 8 carbon atoms, and often 1 to 4 carbon atoms. Examples include methyl, ethyl, propyl, butyl, hexyl, octyl, dodecyl, octadecyl, and phenyl. Oxygen, nitrogen, and/or sulfur-substituted derivatives are also contemplated.

R^{photo} represents a photoremovable group. Exemplary photoremovable groups R^{photo} include phenacyl groups, 2-alkylphenacyl groups, ethylene-bridged phenacyl groups, o- or p-hydroxyphenacyl groups, benzoin-derived groups (e.g., 1,2-di(phenypethanone-2-yl), o-nitrobenzyl groups, o-nitro-2-phenethyloxycarbonyl groups, coumarin-4-yl methyl groups, benzyl groups, o-hydroxylbenzyl groups, o-hydroxynapthyl groups, 2,5-dihydroxylbenzyl groups, 9-phenylthioxanthyl, 9-phenylxanthyl groups, anthraquinon-2-yl groups, 8-halo-7-hydroxyquinoline-2-yl methyl groups, pivaloyl glycol-derived groups, and substituted versions thereof. Of these, o-nitrobenzyl may be preferred in some embodiments.

Methods of functionalizing compounds having active hydrogens (e.g., hydroxyl groups) with photoremovable groups R^{photo} are known in the art and are described, for example, in Petr Klan et al., Photoremovable Protecting Groups in Chemistry and Biology: Reaction Mechanisms and Efficiency; Chemical Reviews (2013), Vol. 113, pp. 119-191 and A. Pelliccioli et al., Photoremovable Protecting Groups: Reaction Mechanisms and Applications, Photochemical and Photobiological Sciences (2002), Vol. 1, pp. 441-458, and references contained therein.

In some embodiments, R^{photo} represents an ortho-nitrobenzyl group.

In some embodiments, at least one photoactivatable reducing agent precursor is represented by the formula:

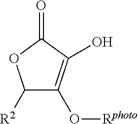

wherein R² and R^{photo} are as previously defined.

In some embodiments, the at least one photoactivatable reducing agent precursor comprises at least one compound represented by the formulas:

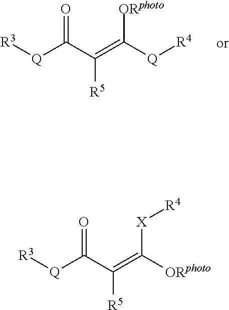

wherein each Q independently represents a direct bond, —O—, —S—, —N(R¹)—, —[C(R¹)₂]_{y}—, —(C═O)—, or —(C═O)O—; and each of R³, R⁴, and R⁵ independently represents hydrogen or an optionally substituted alkyl group having 1 to 18 carbon atoms (e.g., methyl, ethyl, methoxyethyl, propyl, methoxypropyl, butyl, pentyl, hexyl, heptyl, octyl, nonyl, decyl, undecyl, dodecyl, hexadecyl, and octadecyl), except that any two of R³, R⁴, and R⁵ may together form a divalent connecting group (e.g., methylene, ethylene, 1,3-propylene, 1,4-butylene) that forms a 5- or 6-membered ring; y is 1, 2, or 3; and R¹ and R^{photo} are as previously defined. In these embodiments, loss of R^{photo} may result in formation of the corresponding 1,3-diketone:

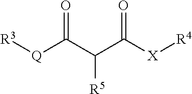

which is capable as functioning as a reducing agent in the redox initiator.

Exemplary photoactivatable reducing agent precursors include: 2-nitrobenzyl-blocked 1,3-cyclopentanedione; 3,4-dimethoxy-2-nitrobenzyl-blocked 2-methyl-1,3-cyclopentanedione; 2-nitrobenzyl-blocked 2-methyl-1,3-cyclohexanedione; 2-nitrobenzyl-blocked 1,3-cyclohexanedione; 2-nitrobenzyl-blocked dimedone; a mixture of 2-nitrobenzyl-blocked β-ketoesters; a mixture of 2-nitrobenzyl-blocked 3-ethyl-2,4-pentanediones; 2-nitrobenzyl blocked 1,3-dimethylbarbituric acid; 2-nitrobenzyl-blocked 5-benzyl-1,3-dimethylbarbituric acid; and combinations thereof.

Typically, the photoactivatable reducing agent precursor(s) is/are present in the free-radically polymerizable composition in an amount of 0.1 to 10 weight percent, preferably 0.3 to 5 weight percent, and more preferably 0.5 to 3 weight percent, based on the total weight of the free-radically polymerizable composition, although other amounts may also be used.

Photopolymerizable compositions according to the present disclosure further comprise at least one reducible transition metal compound comprising at least one of cobalt, copper, iron, manganese, nickel, vanadium, or a combination thereof. Copper is typically preferred. Preferably, the at least one reducible transition metal compound is soluble in the photopolymerizable composition, but this is not a requirement. Exemplary reducible transition metal compounds include their acetylacetonate, 2-ethylhexanoate, acetate, benzoylacetone, 1-phenylpentane-1,3-dione and/or naphthenate complexes although other compounds are permissible.

Typically, the reducible transition metal compound(s) is/are present in the free-radically polymerizable composition in an amount of 0.001 to 1.0 weight percent, preferably 0.01 to 0.5 weight percent, and more preferably 0.05 to 0.3 weight percent, based on the total weight of the free-radically polymerizable composition, although other amounts may also be used.

Photopolymerizable compositions according to the present disclosure further comprise at least one organic peroxide. Exemplary organic peroxides include t-butyl hydroperoxide; t-amyl hydroperoxide; cumene hydroperoxide; diacetone alcohol peroxide; 3-chloroperoxybenzoic acid; aromatic diacyl peroxides such as benzoyl peroxide, di(2-methylbenzoyl) peroxide, di(2-methoxybenzoyl) peroxide, di(2-ethoxybenzoyl) peroxide, di(2-chlorobenzoyl) peroxide; di(3-chlorobenzoyl) peroxide; and di(2,4-dichlorobenzoyl) peroxide; aliphatic diacyl peroxides such as decanoyl peroxide, lauroyl peroxide and myristoyl peroxide; ketone peroxides, such as 1-hydroxycyclohexyl peroxide and 1-hydroperoxycyclohexyl peroxide; aldehyde peroxides such as 1-hydroxyheptyl peroxide; peroxydicathonates such as dicetyl peroxydicarbonate, di(4-t-butylcyclohexyl) peroxydicarbonate and acyl peroxy alkyl carbonates such as acetyl peroxy stearyl carbonate; t-hexyl peroxy-2-ethylhexanoate, t-butyl peroxy-2-ethylhexanoate; t-hexyl peroxy-2-ethylhexanoate, t-butyl peroxy-2-ethylhexanoate, and combinations thereof. Often the organic peroxide is selected to have good storage stability at temperatures of 40° C. or less.

Typically, the organic peroxide(s) is/are present in the free-radically polymerizable composition in an amount of 0.05 to 10 weight percent, preferably 0.1 to 5 weight percent, and more preferably 0.5 to 2 weight percent, based on the total weight of the free-radically polymerizable composition, although other amounts may also be used.

Photopolymerizable compositions according to the present disclosure further comprise at least one photoinitiator (i.e., a free-radically polymerization photoinitiator). Useful photoinitiators include Type I and/or Type II photoinitiators, optionally in combination with one or more sensitizing dye, and/or amine synergist, for example. The at least one photoinitiator does not comprise an organic peroxide as organic peroxide is already included in the composition for other purposes.

Suitable Type I (i.e., Norrish Type I) photoinitiators, which photolyze to form free radicals on absorption of actinic electromagnetic radiation, include benzoin ethers, benzyl ketals, α,α-dialkoxy-acetophenones, α-hydroxyalkylphenones, α-dialkylaminoalkylphenones, acylphosphine oxides, acylphosphines, substituted derivatives thereof, and combinations thereof.

Examples of suitable Type I photoinitiators include 2-benzyl-2-(dimethylamino)-4′-morpholinobutyrophenone; 1-hydroxycyclohexyl phenyl ketone; 2-methyl-1-[4-(methylthio)phenyl]-2-morpholinopropan-1-one; 2-hydroxy-2-methyl-1-phenylpropanone; 1-[4-(2-hydroxyethoxyl)phenyl]-2-hydroxy-2-methylpropanone; 2,2-dimethoxy-2-phenylacetophenone; phenylbis(2,4,6-trimethylbenzoyl)phosphine oxide; phenylbis(2,4,6-trimethylbenzoyl) phosphine; bis(2,4,6-trimethylbenzoyl)phenylphosphine oxide; 2,4,6-trimethylbenzoyldiphenylphosphine oxide; isopropoxyphenyl-2,4,6-trimethylbenzoylphosphine oxide; dimethyl pivaloylphosphonate; ethyl (2,4,6-trimethylbenzoyl)phenyl phosphinate; and bis(cyclopentadienyl) bis[2,6-difluoro-3-(1-pyrryl)phenyl] titanium. These and many others are widely available from commercial sources.

The term “Type II photoinitiator” refers to a compound wherein absorption of electromagnetic radiation (e.g., ultraviolet and/or visible light) causes an excited electron state in the Type II photoinitiator that will abstract a hydrogen from the co-initiator, and in the process, generate free radicals. Exemplary Type II photoinitiators include diaryl ketones (e.g., benzophenone, 4-methylbenzophenone, or 4-chlorobenzophenone), 1-phenylpropane-1,2-dione, thioxanthones (2-isopropylthioxanthone, 2-mercaptothioxanthone, 2,4-diethylthioxanthone, 1-chloro-4-propoxythioxanthone, and 2-chloro-thioxanthone, or 4-isopropylthioxanthone), camphorquinone, benzil, naphthoquinones (e.g., 2,2′-bis(3-hydroxy-1,4-naphthoquinone)), anthraquinones (e g, anthraquinone, 1,4-dihydroxyanthraquinone, 2-methylanthraquinone, or 2,6-dihydroxyanthmquinone), 3-ketocoumarins, and combinations thereof.

Typically, the photoinitiator(s) is/are present in the free-radically polymerizable composition in an amount of 0.01 to 10 weight percent, preferably 0.1 to 5 weight percent, and more preferably 0.5 to 3 weight percent, based on the total weight of the free-radically polymerizable composition, although other amounts may also be used.

In some embodiments, the photopolymerizable compositions according to the present disclosure further comprise at least one tertiary or quaternary ammonium salt.

In some embodiments, photopolymerizable compositions according to the present disclosure further comprise at least one quaternary ammonium salt. In some embodiments, the at least one quaternary ammonium salt comprises at least one quaternary ammonium salt represented by the formula R⁴N⁺X⁻, wherein each R independently represents a hydrocarbyl group having from 1 to 18 carbon atoms and X represents F, Cl, Br, or I. Exemplary R groups include methyl, ethyl, propyl, butyl, hexyl, octyl, decyl, dodecyl, hexadecyl, octadecyl, cyclohexyl, phenyl, benzyl, and phenethyl.

Exemplary quaternary ammonium salts include, tetramethylammonium chloride tetramethylammonium hydroxide, tetramethylammonium bromide, tetramethylammonium hydrogen sulfate, benzyltrimethylammonium chloride, benzyltrimethylammonium bromide, trioctylmethylammonium chloride, benzyltrimethylammonium hydrogen sulfate, benzyltributylammonium chloride, benzyltributylammonium bromide, benzyltributylammonium hydrogen sulfate. Further examples of quaternary ammonium salts are described in U.S. Pat. No. 2,740,765 (Parker); U.S. Pat. No.3,437,715 (Da Fano); and U.S. Pat. No.3,840,618 (Da Fano). Combinations of quaternary ammonium salts may also be used. Many quaternary ammonium salts are available commercially.

In some embodiments, the at least one tertiary or quaternary ammonium salt can be at least one tertiary ammonium salt represented by the formula R₃NH⁺X⁻ wherein R and X are as previously defined.

Exemplary tertiary ammonium salts include dibutyl (2-phenylethyDammonium chloride, trimethylammonium chloride, trimethylammonium bromide, trimethylammonium iodide, N,N-dimethyl-ethylammonium chloride, and/or N,N-dimethylbenzylammonium chloride.

Typically, if present, the tertiary and/or quaternary ammonium salt(s) is/are present in the free-radically polymerizable composition in an amount of 0.01 to 10 weight percent, preferably 0.1 to 5 weight percent, and more preferably 0.1 to 1 weight percent, based on the total weight of the free-radically polymerizable composition, although other amounts may also be used.

The photopolymerizable compositions may contain optional components to enhance their performance. Exemplary such optional components include thixotropes, wetting agents, tackifiers, levelling agents, fillers, thermoplastic polymers, tougheners (e.g., core-shell rubber particles), colorants, light stabilizers, antioxidants, surfactants, plasticizers/flexibilizers, and antimicrobial agents.

Useful fillers may be selected from one or more of a variety of materials and include organic and inorganic fillers. Inorganic fillers include silica, submicron silica, zirconia, submicron zirconia, and non-vitreous microparticles as described in U.S. Pat. No. 4,503,169 (Randklev et al.). Fillers include nanosized silica particles, nanosized metal oxide particles, and combinations thereof. Nanofillers are also described in U.S. Pat. No. 7,090,721 (Craig et al.); U.S. Pat. No. 7,090,722 (Budd et al.); U.S. Pat. No. 7,156,911 (Kangas et al.); and U.S. Pat. No. 7,649,029 (Kolb et al.).

Fillers may be either particulate or fibrous in nature. Particulate fillers may generally be defined as having an aspect ratio of 20:1 or less, and more commonly 10:1 or less. Fibers can be defined as having an aspect ratio of greater than 20:1, and more commonly of greater than 100:1.

Fillers may be surface-treated to provide better compatibility with the monomer matrix. For example, silanization is commonly used.

Fillers may also be selected from the group consisting of a micro-fibrillated polyethylene, a (silanized) fumed silica, talc, a wollastonite, an aluminosilicate clay, a phlogopite mica, calcium carbonate, a kaolin clay, (silanized) silica microspheres, and combinations thereof.

Examples of tougheners include, for example, a methyl methacrylate-butadiene-styrene copolymer (“MBS”), an acrylonitrile-styrene butadiene copolymer, a linear polyurethane, an acrylonitrile-butadiene rubber, a styrene-butadiene rubber, a chloroprene rubber, a butadiene rubber, natural rubbers, and combinations thereof.

Exemplary substrates include metals (e.g., aluminum or stainless steel), plastics (e.g., a polyamide, a polycarbonate), and glasses. In particularly embodiments, the substrate is a glass, whether fritted or non-fritted, and the glass is bonded to another glass, or the glass is bonded to a metal. In some embodiments, the substrate(s) can be transparent (e.g., glass and/or plastic).

When used, the photopolymerizable composition is a unitary composition. However, to improve storage prior to use, the photopolymerizable composition may be divided into a Part A portion and a Part B portion (i.e., a two-part composition). For example, the at least one reducible transition metal compound and the organic peroxide can be included in separate parts to avoid premature reaction. In other embodiments, such as, for example, when at least one tertiary or quaternary ammonium salt is present, the at least one organic peroxide and the at least one tertiary or quaternary ammonium salt is included in separate parts to avoid premature reaction. The remaining components may be in either Part A, Part B, or both Part and Part B.

Photopolymerizable compositions according to the present disclosure can be polymerized/cured by exposure to actinic radiation (i.e., electromagnetic actinic radiation). By definition, actinic radiation is electromagnetic radiation that is absorbed by one or more components of the photopolymerizable composition that ultimately leads to at least partial free-radical polymerization of the composition. Exemplary actinic radiation has a wavelength of from 250 nanometers to 700 nanometers. The actinic radiation is absorbed by both the photoinitiator and the organic photoactivatable reducing agent precursor, either simultaneously or sequentially For example, the same or different wavelengths of actinic radiation may be used for the photoinitiator and the organic photoactivatable reducing agent precursor.

In some embodiments, the photoinitiator may be exposed to the actinic radiation prior to the organic photoactivatable reducing agent precursor, although typically simultaneous exposure is preferred in many instances. Exposure of the photoinitiator to the actinic radiation results in essentially instantaneous polymerization of free-radically polymerizable monomer in the vicinity of where the light is absorbed. Exposure of the organic photoactivatable reducing agent precursor composition to actinic radiation results in at least partial conversion of the organic photoactivatable reducing agent precursor into an organic reducing agent which then participates in a redox reaction to polymerize additional free-radically polymerizable monomer in the vicinity of where the light is absorbed and by diffusion throughout the remainder of the photopolymerizable composition. For optimal performance, the photoinitiator and/or actinic radiation may be selected such that photoinitiator that is located at or near the air interface of the photopolymerizable composition is decomposed and initiates cure before most of the redox cure takes place. In this way, oxygen diffusion (which generally inhibits free-radical polymerization) can be mitigated, as the increased viscosity of the cured composition at the surface will lead to reduced diffusion in the bulk.

The polymerization caused by the decomposition of the photoinitiator is instantaneous and stops when the actinic radiation is discontinued. Redox polymerization continues even after the exposure to actinic radiation is discontinued.

The source(s) of actinic radiation is/are selected such that the actinic radiation is of an appropriate wavelength to be absorbed by the photoinitiator and organic photoactivatable reducing agent precursor, Exemplary sources of actinic radiation may include lasers (ultraviolet or visible), broad spectrum flashlamps (e.g., xenon flashlamps), and low-, medium-, and high-pressure mercury arc lamp mercury arc lamps, microwave-driven mercury lamps (e.g., using H-type, V-type, or D-type bulbs), and light emitting diode (LEDs). Further details associated with radiation curing are with the capabilities of those skilled in the art.

In use, photopolymerizable compositions according to the present disclosure are disposed on a substrate (when used as a sealant) or between two substrates (when used as an adhesive) and then exposed to the actinic radiation for sufficient time (e.g., from less than a second to several minutes) to cause a desired level of polymerization to occur. The photopolymerizable composition may be sandwiched between the first and second substrates prior to irradiation or afterwards. In some embodiments, the photopolymerizable composition may be sandwiched between two releasable liners to make an adhesive transfer tape.

Post-exposure heating may advance and/or accelerate polymerization beyond that achieved by exposure to the actinic radiation.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight. Unless otherwise indicated, all other reagents were obtained, or are available from fine chemical vendors or may be synthesized by known methods. Table 1 (below) lists materials used in the examples and their sources.

TABLE 1

| DESIGNATION | DESCRIPTION | SOURCE |
|---|---|---|
| 3SAB | a 0.002 inch (51 microns) thick primed | Mitsubishi Polyester Film, Greer, |
| | poly(ethylene terephthalate) film | South Carolina |
| | obtained as HOSTOPHAN 3SAB | |
| Acrylic acid | acrylic acid | Merck KGaA, Darmstadt, |
| | | Germany |
| Aerosol R8200 | fumed silica obtained as AEROSIL R | Evonik Industries, Essen, |
| | 8200 | Germany |
| AAP-153 | acrylated acrylic polymer | Synthesized as described in |
| | | Preparative Example 7 |
| A187 | epoxy silane obtained as SILQUEST | Momentive, Waterford, New |
| | A-187 | York |
| AminHCl | Dibutylphenylethylammonium | Alfa Aesar, Ward Hill, |
| | chloride | Massachusetts |
| L-ascorbic acid | 1-ascorbic acid | Alfa Aesar |
| bPhDMBA | ortho-nitrobenzyl-protected dimethyl | Synthesized as described in |
| | phenyl barbituric acid | Preparative Example 4 |
| BTAC | benzyltributylammonium chloride | Alfa Aesar |
| BTAC 40 wt % in | 40 weight percent solution of | Prepared by mixing and stirring |
| HEMA | benzyltributylammonium chloride in | BTAC and HEMA at room |
| | 2-hydroxyethyl methacrylate | temperature until mixture is |
| | | homogeneous |
| Beads | glass spacer beads (diameter 6 mil or | Palmer Holland, North Olmsted, |
| | 152 micrometers) obtained as | Ohio |
| | ENVIROSPHERES SL300 | |
| BzMA | benzyl methacrylate | MilliporeSigma, Burlington, |
| | | Massachusetts |
| BA | n-butyl acrylate | BASF, Florham Park, New Jersey |
| BYK-S-782 | dispersed wax | BYK, Wesel, Germany |
| 10-camphorsulfonic | 10-camphorsulfonic acid | Aldrich Chemical Co. |
| acid | | Milwaukee, Wisconsin |
| Cou-p-AA | coumarin-blocked ascorbate | Synthesized as described in |
| | | Preparative Example 6 |
| Cu(nap)₂ | copper (II) naphthenate, 8% in mineral | Strem Chemicals, Newburyport, |
| | spirits | Massachusetts |
| Copper acetate | copper (II) acetate monohydrate | Merck KGaA |
| monohydrate | | |
| 2,2- | 2,2-dimethoxypropane | TCI Co., Tokyo, Japan |
| Dimethoxypropane | | |
| 1,3-Dimethylurea | 1,3-dimethylurea | Alfa Aesar |
| DMAA | N,N-dimethylacrylamide | TCI Europe, Zwijndrecht, |
| | | Belgium |
| EHA | 2-ethylhexyl acrylate | BASF |
| ESS50F | fibrillated high-density polyethylene | MiniFibers, Johnson City, |
| | fibers Obtained as SHORT STUFF | Tennessee |
| | ESS50F | |
| EPXIEM | polymeric crosslinker | Prepared as described in |
| | | Preparative Example 1 of |
| | | WO2020/250154 |
| Ethyl-4- | ethy1-4-chloroacetoacetate | Alfa Aesar |
| chloroacetoacetate | | |
| GTX-2 | Type II polymeric photoinitiator | Rahn USA, Aurora, Illinois |
| | obtained as GENOPOL TX-2 | |
| HEA | 2-hydroxyethyl acrylate | Kowa America, Torrance, |
| | | California |
| HEMA | hydroxyethyl methacrylate | TCI America, Portland, Oregon |
| HDDA | hexanediol diacrylate | Alfa Aesar |
| HPA | Hydroxypropyl acrylate, mixture of | BASF |
| | isomers | |
| I1010 | Phenolic antioxidant obtained as | BASF |
| | IRGANOX 1010 | |
| I1076 | octadecy1 3-(3,5-di-tert-buty1-4- | BASF |
| | hydroxyphenyl)propionate obtained as | |
| | IRGANOX 1076 | |
| IEM | 2-isocyanatoethyl methacrylate | Showa Denko America, New |
| | | York, New York |
| IBOA | isobornyl acrylate | Osaka Chemical Company, |
| | | Osaka, Japan |
| Kflex | plasticizer obtained as BENZOFLEX | Eastman Chemical, Company, |
| | 9-88 | Kingsport, Tennessee |
| LUPEROX 101 | 2,5-Bis(tert-butylperoxy)-2,5- | Arkema USA, King of Prussia, |
| | dimethylhexane obtained as | Pennsylvania |
| | LUPEROX 101 | |
| MAA | methacrylic acid | MilliporeSigma, St. Louis, |
| | | Missouri |
| Methanesulfonic acid | methanesulfonic acid | Alfa Aesar |
| 3-Methoxyphenol | 3-methoxyphenol | MilliporeSigma |
| 4-methoxyphenol | 4-methoxyphenol | Solvay USA, Princeton, New |
| | | Jersey |
| MMA | methyl methacrylate | MilliporeSigma |
| 2-Nitrobenzyl alcohol | 2-nitrobenzyl alcohol | Alfa Aesar |
| 2-Nitrobenzyl bromide | 2-nitrobenzyl bromide | TCI Co. |
| NVP | N-vinyl pyrrolidone | TCI America |
| OM184 | photoinitiator obtained as OMNIRAD | iGM Resins, Charlotte, North |
| | 184 | Carolina |
| OM651 | photoinitiator obtained as OMNIRAD | iGM Resins |
| | 651 | |
| OM819 | photoinitiator obtained as OMNIRAD | iGM Resins |
| | 819 | |
| PAM 200 | phosphate esters of PPG | Solvay Novacure, Cranbury, New |
| | monomethacrylate obtained as | Jersey |
| | SIPOMER PAM 200 | |
| Phenylmalonic acid | phenylmalonic acid | TCI Co. |
| POCl₃ | phosphorus(v) oxychloride | MilliporeSigma |
| Propylene carbonate | propylene carbonate | Acros Organics, Fair Lawn, New |
| | | Jersey |
| PIPAA | nitrobenzyl protected isopropylidene | Synthesized as described in |
| | ascorbic acid. | Preparative Example 5 |
| RF02N | A 75 microns thick silicone-coated | SKC Haas, Seoul, South Korea |
| | poly(ethylene terephthalate) film | |
| | release liner obtained as RF02N | |
| tert-dodecy1 | tert-dodecyl mercaptan | TCI America |
| mercaptan | | |
| TR2250 | Silicone polyether acrylate obtained as | Evonik Industries |
| | TEGO RAD 2250 | |
| Trifluoroacetic acid | Trifluoroacetic acid | Oakwood Chemical |
| TS-720 | Fumed silica obtained as CAB-O-SIL | Cabot Corporation, Boston |
| | TS-720 | Massachusetts |
| TBEC | tert-butylperoxy 2-ethylhexyl | MilliporeSigma |
| | carbonate | |
| TAH85 | 85 wt. % tert-amyl hydroperoxide in | Arkema, King of Prussia, |
| | water | Pennsylvania |
| UDMA | Urethane dimethacrylate obtained as | Arkema |
| | CN 1964 | |
| VAZO 52 | Thermal radical initiator obtained as | Chemours, Wilmington, |
| | VAZO 52 | Delaware |
| VAZO 67 | Thermal radical initiator obtained as | Chemours |
| | VAZO 67 | |
| VAZO 88 | Thermal radical initiator obtained as | Chemours |
| | VAZO 88 | |
| Wacker H21 | Pyrogenic silica obtained as HDK H21 | Wacker Chemie, Munich, |
| | | Germany |
| XT100 | Methyl methacrylate-butadiene-styrene | Arkema |
| | (MBS) core-shell impact modifier | |
| | obtained as CLEARSTRENGTH | |
| | XT100 | |

### Test Methods

### Fourier Tranform Infrared Spectroscopy (FTIR) Specimen Sandwich Construction

The components of a given mixture were combined in a polypropylene mixing cup (FlackTek, Inc., Landrum, South Carolina) and blended in a SPEEDMIXER (Hauschild SpeedMixer Inc., Dallas, Texas) high shear mixer for 30 seconds at 2000 revolutions per minute (rpm). Directly after mixing, a large drop of formulation was sandwiched between two glass microscope slides: setup consists of a top slide (1 in×3 in (2.5 cm×7.6 cm), pre-cleaned, VWR 48300-025)+silicone rubber gasket (15 mil thick, 1 in×3 in (2.5 cm×7.6 cm))+bottom slide (2 in×3 in (5.1 cm×7.6 cm), pre-cleaned, VWR 48382-179), attached with small binder clips at top and bottom. The rubber gasket had a circle in the middle cut out to allow room for the formulation.

### Cure Monitoring by FTIR (Individual Spectrum)

A given FTIR sandwich specimen (prepared as above) was placed into a Nicolet IR iS50 spectrometer (Nicolet Thermo Fisher Scientific Inc., Waltham, Massachusetts). Spectra were taken in a range of 4000-7000 cm⁻¹. The spectra were taken at specific times as reported for each individual example. The spectra were analyzed for disappearance of the acrylate/methacrylate peak centered at 6165 cm⁻¹. This disappearance was translated into a % cure value using the equation:

$$\% conversion at time t = \frac{100 \times ( ( integration at time 0 ) - ( integration at time t ) )}{( integration at time 0 )}$$

wherein time 0 represents the formulation prior to irradiation.

### Cure Monitoring by FTIR (Series)

A given FTIR sandwich specimen (prepared as above) was placed into a Nicolet IR iS50 spectrometer. A series of spectra was collected in the range of 4000-7000 cm⁻¹. One spectrum was taken every 5 seconds for a total time defined in each specific example. The series of spectra was analyzed for disappearance of the acrylate/methacrylate peak centered at 6165 cm⁻¹. Disappearance of the 6165 cm⁻¹. peak was translated into a % cure value using the equation:

$$\% conversion at time t = \frac{100 \times ( ( integration at time 0 ) - ( integration at time t ) )}{( integration at time 0 )}$$

with time 0 being the first integration acquired in the series.

### Irradiation of Sandwich Specimen With LX-400 in FTIR Spectrometer

A given FTIR sandwich specimen was placed into a Nicolet IR iS50 spectrometer. The circular cutout in the sandwich specimen that contained the resin was irradiated by an OMNICURE LX-400 UV LED Spot Curing System (available from Excelitas Technologies, Waltham, Massachusetts). The ultraviolet (UV) light had a peak wavelength centered at 365 nm the power was set to 100%, and the distance between the light source and the specimen was 1.3 cm. In some cases, this irradiation was done while a series of IR spectra was in progress. The timing details of the irradiation were reported for each individual example.

### Cure Monitoring by Attenuated Total Reflectance FTIR (ATR-FTIR) (Individual Spectrum)

When appropriate, release liner was removed from a film specimen. The film was placed material-down on the ATR-FTIR sensor of a Nicolet IR iS50 spectrometer. Spectra were taken in a range of 1000-4000 cm⁻¹. These spectra were taken at specific times that are defined in each individual example. The spectra were analyzed for disappearance of the acrylate/methacrylate peak centered between 1650-1620 cm⁻¹. This disappearance was translated into a % cure value using the equation:

$$\% conversion at time t = \frac{100 \times ( ( integration at time 0 ) - ( integration at time t ) )}{( integration at time 0 )}$$

wherein time 0 represents the formulation prior to irradiation.

### Overlap Shear Test (Aluminum Substrates)

Aluminum substrates (1 inch×4 inches×0.064 inch, (2.5 cm×10 cm×0.16 cm)) to be tested were washed with methyl ethyl ketone, air dried for at least 10 minutes, then abraded with a SCOTCH-BRITE GENERAL PURPOSE HAND PAD #7447 (3M, St. Paul, Minnesota). Each specimen to be tested was spread at 10 mil (254 microns) thick using a BYK-Gardner multiple clearance square applicator, 2 in (5.1 cm), 5-50 mils (0.13-1.3 mm, Thomas Scientific, Swedesboro, New Jersey) over the abraded portion of the substrate. The substrate was irradiated with actinic electromagnetic radiation as described in the individual examples. A second abraded aluminum substrate was applied to the irradiated specimen, thus closing the bond (bond area=0.5 inch×1 inch (1.3 cm×2.5 cm)). The bond was clamped with binder clips and allowed to sit at room temperature for 24 hours prior to testing. Dynamic overlap shear testing was performed at ambient temperature using an MTS Sintech Tensile Tester (MTS Systems, Eden Prairie, Minnesota). Specimens were loaded into the grips and the crosshead was operated at 0.2 inches per minute (0.5 cm/min), loading the specimen to failure. Stress at break was recorded in units of pounds per square inch (psi), and also reported in kilopascals (kPa).

### Overlap Shear Test (Nylon Substrates)

Nylon substrates (1 inch×4 inches×0.25 inch, (2.5 cm×10 cm×1.3 cm)) to be tested were washed with isopropyl alcohol and air dried for at least 10 minutes. The specimen to be tested was spread at 10 mil thick using a BYK-Gardner multiple clearance square applicator, 2 inches (5.1 cm), 5-50 mils (0.13-1.3 mm, Thomas Scientific) over the substrate. The substrate was irradiated with to actinic electromagnetic radiation as described in the individual examples. A second nylon substrate was applied to the irradiated specimen, thus closing the bond (bond area =0.5 inch×1 inch (1.3 cm×2.5 cm)). The bond was clamped with binder clips and allowed to sit at room temperature for 24 h prior to testing. Dynamic overlap shear testing was performed at ambient temperature using an MTS Sintech Tensile Tester, specimens were loaded into the grips and the crosshead was operated at 2 inches per minute (5.1 cm/min), loading the specimen to failure. Stress at break was recorded in units of pounds per square inch (psi), and also reported in kilopascals (kPa).

### 180° Peel Adhesion Test

Peel adhesion strength was measured at a 180° peel angle using an IMASS SP-200 slip/peel tester (IMASS, Inc., Accord, Massachusetts) at a peel rate of 305 mm/minute (12 inches/minute). Stainless steel (SS) test panels were cleaned with acetone and a clean KIMWIPE tissue (Kimberly-Clark, Irving, Texas) three times. The cleaned panel was dried at room temperature. Polypropylene (PP) test panels were wiped with a dry KIMWIPE tissue to remove dust and then used directly. The adhesive was laminated to 3 SAB liner and allowed to dwell for 24 hours. The adhesive coated film was cut into tapes measuring 1.27 cm×20 cm (½ in×8 in). A test specimen was prepared by rolling the tape down onto a cleaned panel with 3 passes of a 2.0 kg (4.5 lb.) rubber roller. The prepared specimens were dwelled at 23° C. and 50% relative humidity (RH) for 0 to 15 minutes before testing. One or two specimens were tested for each example. The resulting peel adhesion was reported in ounces/inch and N/cm. The failure mode was also recorded for each peel specimen.

### Static Shear Test

Stainless steel (SS) plates were prepared for testing by cleaning with acetone and a clean KIMWIPE tissue three times. Adhesive films to be tested were laminated to 3SAB and allowed to dwell for 24 hours. The adhesive films described were cut into strips (1.27 cm in width) and adhered by their adhesive to flat, rigid stainless-steel plates with exactly 2.54 cm length of each adhesive film strip in contact with the plate to which it was adhered. A weight of 2 kilograms was rolled over the adhered portion with three passes. Each of the resulting plates with the adhered film strip was equilibrated at room temperature for 60 minutes. Afterwards, the specimens were transferred to a room with 23° C. and 50% relative humidity, in which a 500 g weight was hung from the free end of the adhered film strip with the panel tilted 2° from the vertical to insure against any peeling forces. The time (in minutes) at which the weight fell, as a result of the adhesive film strip releasing from the plate, was recorded. The test was discontinued at 10,000 minutes if there was no failure. In the results, this scenario is designated as 10,000+minutes. One or two specimens of each tape (adhesive film strip) were tested and if two specimens were used, the static shear strength tests were averaged to obtain the reported static shear values. Additionally, for specimens that did not hang for 10,000+minutes, the failure modes of the specimens were recorded.

### Gravimetric Residuals Test

To determine the amount of volatile chemicals remaining after curing, the following procedure was used. Small aluminum weighing pans were weighed, and the weights were recorded for each. The polymer specimen to be measured was either cured directly on the pans or added to the pans after curing. The combined weight of the pan and polymer was taken and recorded. For aged residuals testing, at this point the polymer was covered by RF02N release liner and the specimen was aged for the appropriate time at which point the liner was removed. The pans with the polymer were added to a solvent-rated forced air oven set at 120° C. After 3 hours, the pans were removed, and the final dried weights were taken. The ratio of the polymer weight after drying and before drying gave the percentage of solid material, and its inverse was reported as the percent residual volatiles.

### Preparative Examples PE1-A to PE1-D

Composition of the base formulations PE1-A to PE1-D are reported in Table 2. Each formulation was prepared by combining all components into a polypropylene mixing cup. The cup was closed with a polypropylene lid and the mixture was high shear mixed at ambient temperature and pressure using a SPEEDMIXER for at least 60 seconds(s) at 2000 revolutions per minute (rpm). When necessary, heat (up to 70° C.) was used to facilitate homogenizing the formulations.

TABLE 2

| | PE1-A | PE1-B | PE1-C | PE1-D |
|---|---|---|---|---|
| COMPONENT | grams | | | |
| BZMA | 24.1 | | 22.6 | 20.6 |
| HEMA | 24.4 | 29.1 | 22.4 | 22.4 |
| PAM 200 | 3.2 | | 3.0 | 3.0 |
| MAA | | 3.6 | | |
| MMA | | 24.0 | | |
| EPXIEM | 26.5 | 31.7 | | |
| UDMA | | | 30.0 | 30.0 |
| CU (NAP)₂ | 0.1 | 0.1 | | 0.2 |
| BTAC 40 WT % IN HEMA | 0.4 | 2.1 | | 2.0 |
| BYK-S-782 | 1.1 | 0.4 | | |
| XT100 | 17.9 | | 17.0 | 16.8 |
| ESS50F | 2.0 | | 2.0 | 2.0 |
| TS-720 | | | 3.0 | 3.0 |
| WACKER H21 | | 4.5 | | |
| AEROSIL R8200 | | 4.5 | | |
| BEADS | 0.3 | | | |

### Preparative Example 2

The contents of the accelerator formulations PE2-A to PE2-E are reported in Table 3. Each formulation was prepared by combining all components into a polypropylene mixing cup. The cup was closed with a polypropylene lid and the mixture was high shear mixed at ambient temperature and pressure using a SPEEDMIXER for at least 60 s at 2000 rpm. When necessary, heat (up to 70° C.) was used to facilitate homogenizing the formulations.

TABLE 3

| | PE2-A | PE2-B | PE2-C | PE2-D | PE2-E |
|---|---|---|---|---|---|
| COMPONENT | grams | | | | |
| bPHDMBA | 15.7 | | 8 | | |
| COU-P-AA | | | | 16 | |
| OM819 | | | | | 6.7 |
| XT100 | 10.7 | 18.3 | 14.7 | 16.7 | 16.7 |
| KFLEX | 32.2 | 54.9 | 44.2 | 50.6 | 58.3 |
| TBEC | 15.7 | | 8.2 | 10 | 10 |
| TS-720 | 8.7 | 9.3 | 6.5 | 6.7 | 8.3 |
| PROPYLENE | 17 | 17.5 | 18.5 | | |
| CARBONATE | | | | | |

### Preparative Example 3

The compositions of inkjet printable pressure sensitive adhesive formulations PE3-A to PE3-C are reported in Table 4. Each formulation was prepared by mixing acrylic monomer and polymer components in a glass jar, followed by addition of all remaining components and homogenization by rolling on a jar roller for at least 1 hour.

TABLE 4

| | PE3-A | PE3-B | PE3-C |
|---|---|---|---|
| EXAMPLE | Parts by weight | | |
| AAP153 | 4.7 | 4.54 | 4.54 |
| EHA | 56.36 | 54.49 | 54.49 |
| IBOA | 18.79 | 18.16 | 18.16 |
| HEA | 18.79 | 18.16 | 18.16 |
| TR2250 | 0.06 | 0.05 | 0.05 |
| A187 | 0.09 | 0.09 | 0.09 |
| I1076 | 0.28 | 0.27 | 0.27 |
| OM819 | 0.94 | 0.91 | |
| GTX-2 | | | 0.91 |
| BPHDMBA | | 0.27 | 0.27 |
| CU(NAP)₂ | | 0.09 | 0.09 |
| TBEC | | 1.82 | 1.82 |
| 40 WT % BTAC IN HEMA | | 1.13 | 1.13 |

### Preparative Example 4 (bPhDMBA)

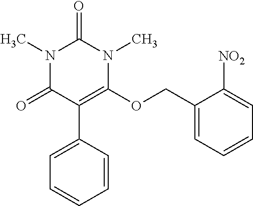 [SMILES: Cn1c(OCc2ccccc2[N+](=O)[O-])c(-c2ccccc2)c(=O)n(C)c1=O]

The synthesis of bPhDMBA was carried out in three steps.

### Step 1: Preparation of 1,3-dimethyl-5-phenylbarbituric Acid

To a solution of 1,3-dimethylurea (2.66 grams, 30.0 mmol) and phenylmalonic acid (5.40 grams, 30.0 mmol) in chloroform (70 mL) was added glacial acetic acid (5.5 mL, 96 mmol). The resultant reaction mixture was heated at 50° C. Acetic anhydride (11.3 mL, 120. mmol) and trifluoroacetic acid (0.5 mL, 6.6 mmol) were added, and the reaction mixture was then heated at reflux while stirring overnight. The following morning, the volatile components were removed under reduced pressure, and the residue was added to water (100 mL). After stirring for 2 hours, the formed solid was collected via filtration and washed with additional water. The solid was then dissolved in dichloromethane (DCM) and washed with saturated aqueous sodium chloride. The organic layer was dried over anhydrous magnesium sulfate, filtered, and concentrated to afford 1,3-dimethyl-5-phenylbarbituric acid (4.20 grams, 60% yield) as a white solid.

### Step 2: Preparation of 1,3-dimethyl-5-phenyl-6-chlorouracil

1,3-Dimethyl-5-phenylbarbituric acid (4.20 grams, 18.1 mmol) was dissolved in POCl₃ (30 mL). Water (1.0 mL) was added dropwise to the mixture, resulting in a significant exotherm. Once the exotherm had subsided, the mixture was heated at reflux for 4 hours. The majority of the POCl₃ was then removed under reduced pressure, and cold water was added to the residue. The mixture was extracted with DCM (3×75 mL). The combined organic layers were washed sequentially with saturated aqueous NaHCO₃, water, and saturated aqueous sodium chloride, then dried over anhydrous magnesium sulfate, filtered, and concentrated to provide an orange oil. Purification of this material via suction filter column (SiO₂, 3:1 hexane/ethyl acetate eluent) afforded 1,3-dimethyl-5-phenyl-6-chlorouracil (4.30 grams, 95% yield) as a white solid.

### Step 3: Preparation of bPhDMBA

Benzyltributylammonium chloride (0.54 grams, 1.7 mmol) and 2-nitrobenzyl alcohol (3.94 grams, 25.7 mmol) were added to a solution of NaOH (3.43 grams, 85.8 mmol) in water (80 mL). A solution of the 1,3-dimethyl-5-phenyl-6-chlorouracil (4.30 grams, 17.15 mmol) in DCM (50 mL) was then added. The resultant biphasic mixture was stirred vigorously overnight at room temperature. The following morning, the aqueous layer was adjusted to pH˜6, then extracted with DCM (3×75 mL). The combined organic layers were then washed sequentially with water and saturated aqueous sodium chloride, then dried over anhydrous magnesium sulfate, filtered, and concentrated to an orange oil. Purification of this material via suction filter column (SiO₂, 1:1 hexane/ethyl acetate eluent) afforded the product bPhDMBA (3.14 grams, 50% yield) as a white solid.

### Preparative Example 5 (PIPAA)

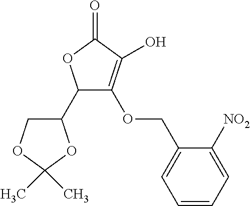 [SMILES: CC1(C)OCC(C2OC(=O)C(O)=C2OCc2ccccc2[N+](=O)[O-])O1]

The synthesis of PIPAA was carried out in two steps.

### Step 1: Preparation of 5,6-O-isopropylidene-L-ascorbic Acid

This material was prepared according to literature precedence (Dalhgren et. al. “Solid-phase library synthesis of reversed-statine type inhibitors of the malarial aspartyl proteases plasmepsin I and II” Bioorganic & Medicinal Chemistry, 2003, 11(6), 827-841). To a suspension of L-ascorbic acid (20.0 g, 114 mmol) in acetone (200 mL) was added 2,2-dimethoxypropane (20.4 g, 196 mmol) and 10-camphorsulfonic acid (1.32 g, 5.68 mmol). The resultant mixture was stirred overnight at room temperature. To the resultant slurry was added approximately 0.6 g triethylamine. A portion of hexane was added to the mixture, and the white precipitate was collected via vacuum filtration, washing with additional hexane. The material was dried under vacuum to afford the desired product (21.0 g, 86% yield).

### Step 2: Preparation of PIPAA

Potassium carbonate (3.03 g, 21.9 mmol) was added to a solution of 5,6-O-isopropylidene-L-ascorbic acid (4.73 g, 21.9 mmol) in 40 ml of 1:1 tetrahydrofuran/dimethyl sulfoxide. The resultant mixture was allowed to stir for 30 min. A solution of 2-nitrobenzyl bromide (4.73 g, 21.9 mmol) in 20 mL of 1:1 tetrahydrofuran/dimethyl sulfoxide was then added dropwise via addition funnel over 10 min. The resultant mixture was stirred under nitrogen atmosphere overnight, during which time it became dark orange in color. Following removal of the tetrahydrofuran under reduced pressure, approximately 200 mL of water was added to the mixture, which was then extracted with ethyl acetate (3×). The combined organic layers were washed with water (3×) and saturated aqueous sodium chloride, dried over anhydrous magnesium sulfate, filtered, and concentrated to a yellow solid. This material was purified via trituration with 2/1 hexane/ethyl acetate to afford 4.47 g of PIPAA product as a pale yellow solid (58% yield).

### Preparative Example 6 (Cou-p-AA)

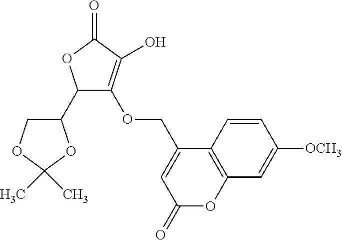 [SMILES: COc1ccc2c(COC3=C(O)C(=O)OC3C3COC(C)(C)O3)cc(=O)oc2c1]

The synthesis of Cou-p-AA was carried out in three steps.

### Step 1: Preparation of 7-methoxy-4-chloromethyl Coumarin

3-Methoxyphenol (3.72 grams, 30.0 mmol) and ethyl-4-chloroacetoacetate (7.41 grams, 45.0 mmol) were added to methanesulfonic acid (40 mL), and the resultant mixture was allowed to stir at room temperature overnight. The mixture was then poured onto ice water, and the resultant purple-gray colored precipitate was collected via filtration, washing with copious amounts of water. The resultant material was dissolved in ethyl acetate (200 mL) and washed with saturated aqueous NaHCO₃ (2×200 mL). The organic layer was washed with saturated aqueous sodium chloride (1×100 mL), then dried over anhydrous magnesium sulfate, filtered, and adsorbed onto silica gel. Purification via suction filter column (SiO₂, elute with 1:1 hexanes/ethyl acetate) affords the product (6.20 grams, 92% yield) as a light yellow-to-tan colored solid.

### Step 2: Preparation of 7-methoxy-4-iodomethyl Coumarin

The 7-methoxy-4-chloromethyl coumarin prepared in the previous step (0.45 grams, 2.0 mmol) was dissolved in acetone (20 mL) to generate a homogeneous, orange-colored solution. Potassium iodide (1.0 grams, 6.0 mmol) was added, and the resultant mixture was heated at reflux overnight under a nitrogen atmosphere. The following morning, the reaction mixture was cooled to room temperature, and the white precipitate which had formed was removed via filtration through Celite (Imerys, Paris, France), washing with additional acetone. The filtrate was concentrated to afford an orange-colored solid which was dissolved in ethyl acetate (100 mL), and the solution was washed with water (1×100 mL) and saturated aqueous sodium chloride (1×100 mL). The organic layer was then dried over anhydrous magnesium sulfate, filtered, and concentrated to afford the product (0.63 grams, 98% yield) as an orange solid, which was used without further purification.

### Step 3: Preparation of Coumarin-Blocked Ascorbate (Cou-p-AA)

The isopropylidene-protected ascorbic acid (0.86 grams, 4.0 mmol) obtained in Step 1 of Preparative Example 5 was dissolved in 1:1 tetrahydrofuran/dimethyl sulfoxide (40 mL), and potassium carbonate (0.55 grams, 4.0 mmol) was added. The resultant mixture was allowed to stir for 30 minutes under a nitrogen atmosphere. A solution of the 7-methoxy-4-iodomethylcoumarin prepared in the previous step (0.62 grams, 2.0 mmol) in 1:1 tetrahydrofuran/dimethyl sulfoxide (40 mL) was added dropwise via addition funnel over 30 minutes. The resultant, orange-colored mixture was allowed to stir at room temperature under nitrogen atmosphere overnight. The following morning, the tetrahydrofuran was removed via rotary evaporation, and the remainder of the mixture was added to water (200 mL). This mixture was extracted with ethyl acetate (3×75 mL), and the combined organic layers were washed with saturated aqueous sodium chloride (1×100 mL), dried over anhydrous magnesium sulfate, filtered, and concentrated to an orange oil which was adsorbed onto silica gel. Purification via suction filter column (SiO₂, eluted with ethyl acetate) affords the Cou-p-AA product (0.34 grams, 43% yield) as a thick orange oil.

### Preparative Example 7 (AAP-153)

The synthesis of AAP-153 was carried out in two steps.

### Step 1: Preparation of Hydroxy-Functional Acrylic Polymer

A solution was prepared by combining EHA (30.8 grams), BA (30.0 grams), IBOA (13.0 grams), HPA (15.0 grams), NW (10.0 grams), I1010 (0.10 grams), tent-dodecyl mercaptan (2.0 grams), and a 4.76 weight percent solution of 4-methoxyphenol in EHA (0.42 grams) in a glass jar. A 0.12 weight percent solution of VAZO 52 in EHA (0.80 grams) was added to the jar. An aliquot (80 grams) of the mixture was transferred to a stainless steel reactor (VSP2 adiabatic reaction apparatus equipped with a 316 stainless steel that can be obtained from Fauske and Associated Inc., Burr Ridge, Illinois). The reactor was purged of oxygen while heating and stirring, and pressurized with 60 psi of nitrogen gas before reaching the induction temperature of 62° C. The polymerization reaction proceeded under adiabatic conditions to a peak reaction temperature of 126° C. An aliquot (5.0 grams) was taken from the reaction mixture and the unreacted monomer was measured by mass loss after heating at 150° C. for 45 minutes. The unreacted monomer was found to be 61.6 weight percent. A solution was prepared by mixing VAZO 52 initiator (0.24 grams), VAZO 67 initiator (0.08 grams, VAZO 88 initiator (0.12 grams), LUPEROX 101 peroxide (0.24 grams), and ethyl acetate (19.32 grams) in a glass jar. The solution was shaken for approximately 10 minutes to dissolve the solids. Then an aliquot of the solution (0.70 grams) and tent-dodecyl mercaptan (0.80 grams) was stirred into the stainless steel reactor. The reactor was purged of oxygen while heating and stirring, and then pressurized with 60 psi (0.4 MPa) of nitrogen gas before reaching the induction temperature of 60° C. The polymerization reaction proceeded under adiabatic conditions to a peak reaction temperature of 170° C. The mixture was isothermally held at the peak temperature for 30 minutes and then poured into a glass jar. A sample was taken and the unreacted monomer was measured by mass loss after heating at 150° C. for 45 minutes. The unreacted monomer was found to be 4.90 weight percent. The mixture was collected and used in Step 2 (see below)

The molecular weight distribution of the acrylic copolymer polymerized above was characterized using gel permeation chromatography (GPC). The GPC instrumentation (obtained from Waters Corporation (Milford, Massachusetts)) included a high-pressure liquid chromatography pump (Model Alliance e2695), a UV detector (Model 2489), and a refractive index detector (Model 2414). The chromatograph was equipped with two STYRAGEL HR 5E 5 micron mixed bed columns (available from Waters Corporation). GPC samples were prepared by dissolving polymer samples in tetrahydrofuran at a concentration of 0.5 percent (weight/volume) and filtering through a polytetrafluoroethylene filter (0.2 micron, available from VWR International (West Chester, Pennsylvania)). The resulting samples were injected into the GPC and eluted at a rate of 1 milliliter per minute through the columns maintained at 35° C. The system was calibrated with polystyrene standards using a linear least square fit analysis to establish a calibration curve. The hydroxy-functional acrylic polymer weight average molecular weight (M_{W}) calculated from this standard calibration curve was 16.0 kDa.

### Step 2: Methacrylate Functionalization of Acrylic Polymer to Produce AAP-153

The hydroxy-functional acrylic polymer obtained from PE7 Step 1 (61.8 grams) was added to a glass round bottom flask fitted with an overhead stirring motor and a stainless steel stir blade. The flask was submersed in an oil bath and heated with stirring to 90° C. Once at temperature, IEM (8.04 grams) was added to the flask and the mixture was held at 90° C. with stirring for two hours, after which the polymer was poured into a glass jar and allowed to cool to room temperature.

### Examples EX1 to EX2 and Comparative Examples CE1 to CE4

Example formulations EX1 and EX2 along with Comparative Example formulations CE1 to CE4 were prepared according to the compositions reported in Table 5. Each formulation was combined in a polypropylene mixing cup and prepared according to the General Procedure for FTIR Specimen Sandwich Construction. An initial FTIR spectrum of each specimen was taken immediately after preparing the FTIR sandwich, followed by a 15 min FTIR series (see General Procedures for individual spectra and series). When specified, irradiation by LX400 was started at approximately 2 min into the series followed by the approximately 13 min remaining of the series occurring without light. A further spectrum was taken after the series. A final spectrum was taken after the designated amount of time reported on Table 6. According to the cure monitoring by FTIR series and/or individual spectrum analysis procedure(s), the percent (%) cure values at various points were calculated and are reported in Table 6.

TABLE 5

| | BASE | | | ACCELERATOR | | | | |
|---|---|---|---|---|---|---|---|---|
| | FORMULATION | | | FORMULATION | | | | PHOTO- |
| | PE1- | PE1- | PE1- | PE2- | PE2- | PE2- | PE2- | INITIATOR |
| EXAM- | A | C | D | A | B | D | E | OM819 |
| PLE | grams | | | | | | | |
| CE1 | 2.0 | | | 0.1 | 0.1 | | | |
| EX1 | 2.0 | | | 0.1 | 0.1 | | | 0.012* |
| CE2 | 2.0 | | | | 0.2 | | | 0.022* |
| CE3 | | | 2.0 | | | 0.2 | | |
| CE4 | | 2.0 | | | | | 0.2 | 0.013** |
| EX2 | | | 2.0 | | | 0.1 | 0.1 | 0.007** |

In Table 5, *indicates that the OM819 was added separately to the formulation, in addition to the base and accelerator components.
In Table 5, **indicates that the OM819 was contained in the PE2-E component that was added; it was not added separately.

In Table 6 (below) zero conversion had taken place at the start of monitoring cure.

TABLE 6

| | LX400 | | FINAL | TIME OF FINAL |
|---|---|---|---|---|
| | IRRADIATION | CONVERSION | CONVERSION, | CONVERSION, |
| EXAMPLE | TIME, seconds | AFTER SERIES, % | % | hours |
| CE1 | 0 | 10 | 14 | 24 |
| CE1 | 5 | 45 | 78 | 24 |
| CE1 | 30 | 51 | 95 | 24 |
| EX1 | 0 | 6 | 7 | 24 |
| EX1 | 5 | 53 | 82 | 24 |
| EX1 | 30 | 66 | 97 | 24 |
| CE2 | 0 | 2 | 7 | 120 |
| CE2 | 5 | 46 | 47 | 120 |
| CE2 | 30 | 72 | 91 | 120 |
| CE3 | 0 | 3 | 12 | 48 |
| CE3 | 5 | 46 | 80 | 48 |
| CE3 | 30 | 72 | 90 | 48 |
| CE4 | 0 | 2 | 5 | 48 |
| CE4 | 5 | 47 | 54 | 48 |
| CE4 | 30 | 68 | 81 | 48 |
| EX2 | 0 | 5 | 9 | 48 |
| EX2 | 5 | 73 | 86 | 48 |
| EX2 | 30 | 83 | 94 | 48 |

### Examples EX3 to EX4 and Comparative Examples CE5 to CE6

The compositions of the Example formulations EX3 to EX4 and Comparative Example formulations CE5 to CE6 are reported in Table 7. Each formulation was prepared in a polypropylene mixing cup, blended in a SPEEDMIXER high shear mixer at 2000 rpm for 30 seconds, and immediately coated into a film (approximately 1 g formulation per film, 10 mils (254 microns) thick) using a knife coater. Half of the films were coated between release liners; half of the films were coated without a top release liner. Each film was cut in half using scissors. Half of each film was irradiated using an OMNICURE AC475 365 nm LED at ˜95% power set over a conveyer belt running at 2 feet per minute (0.6 meters/minute). The total irradiation dose amounted to 2 J/cm² in the UVA range as measured with a POWERPUCK II (EIT, Leesburg, Virginia). The second half of each film was not irradiated. Following irradiation (or lack of irradiation), films were moved under a hood until analysis. Note OM184 was used instead of OM819 to minimize any potential additional ambient light curing. The mixed formulations were evaluated by ATR-FTIR one hour after mixing; the resulting spectra were used as the initial references. After 27 hours, the films were analyzed by ATR. Films cured between release liners were evaluated by ATR at three locations: middle of the film, ˜1 cm from the film edge, and the edge of the film. Films cured without a top release liner (open-faced films) were evaluated in the middle of the film. The results of the ATR curing studies are reported in Table 8.

TABLE 7

| | | | ACCELERATOR | PHOTO- |
|---|---|---|---|---|
| | BASE FORMULATION | | FORMULATION | INITIATOR |
| | PE1-A | PE1-B | PE2-C | OM184 |
| EXAMPLE | grams | | | |
| CE5 | 5.0 | | 0.5 | |
| EX3 | 5.0 | | 0.5 | 0.275 |
| CE6 | | 5.0 | 0.5 | |
| EX4 | | 5.0 | 0.5 | 0.275 |

TABLE 8

| | | | | LOCATION | % |
|---|---|---|---|---|---|
| ENTRY | EXAMPLE | FORM | IRRADIATED? | MEASURED | CONVERSION |
| 1 | CE5 | formulation | no | n/a | 0 |
| 2 | CE5 | film | no | middle of film | 0 |
| | | between | | | |
| | | liners | | | |
| 3 | CE5 | film | yes | middle of film | 85 |
| | | between | | | |
| | | liners | | | |
| 4 | CE5 | film | yes | 1 cm from film | 85 |
| | | between | | edge | |
| | | liners | | | |
| 5 | CE5 | film | yes | edge of film | 60 |
| | | between | | | |
| | | liners | | | |
| 6 | CE5 | open-faced | yes | middle of film | 71 |
| | | film | | | |
| 7 | EX3 | formulation | no | n/a | 0 |
| 8 | EX3 | film b/w | no | middle of film | 5 |
| | | liners | | | |
| 9 | EX3 | film b/w | yes | middle of film | 90 |
| | | liners | | | |
| 10 | EX3 | film b/w | yes | 1 cm from film | 91 |
| | | liners | | edge | |
| 11 | EX3 | film b/w | yes | edge of film | 86 |
| | | liners | | | |
| 12 | EX3 | open-faced | yes | middle of film | 72 |
| | | film | | | |
| 13 | CE6 | formulation | no | n/a | 0 |
| 14 | CE6 | film b/w | no | middle of film | 5 |
| | | liners | | | |
| 15 | CE6 | film b/w | yes | middle of film | 96 |
| | | liners | | | |
| 16 | CE6 | film b/w | yes | 1 cm from film | 97 |
| | | liners | | edge | |
| 17 | CE6 | film b/w | yes | edge of film | 78 |
| | | liners | | | |
| 18 | CE6 | open-faced | yes | middle of film | 40 |
| | | film | | | |
| 19 | EX4 | formulation | no | n/a | 0 |
| 20 | EX4 | film b/w | no | middle of film | 3 |
| | | liners | | | |
| 21 | EX4 | film b/w | yes | middle of film | 100 |
| | | liners | | | |
| 22 | EX4 | film b/w | yes | 1 cm from film | 100 |
| | | liners | | edge | |
| 23 | EX4 | film b/w | yes | edge of film | 95 |
| | | liners | | | |
| 24 | EX4 | open-faced | yes | middle of film | 91 |
| | | film | | | |

### Examples EX5 to EX6 and Comparative Examples CE7 to CE8

The compositions of the Example formulations EX5 to EX6 and Comparative Example formulations CE7 to CE8 are reported in Table 9. Each formulation was prepared in a polypropylene mixing cup and blended in a SPEEDMIXER high shear mixer at 2000 rpm for 30 seconds. Within 30 min after mixing, the formulations were used to prepare overlap shear specimens on aluminum and nylon substrates according to the respective Overlap Shear Test. The substrates were irradiated open-faced using the Omnicure AC475 365 nm LED set above a variable-speed conveyor. The light source was operated at 85% power and the conveyor speed was 2 feet per minute (0.6 m/min). This resulted in 1.9 J/cm² UVA total irradiation as measure by a POWERPUCK II (EIT). The substrate bonds were closed within 5 min after irradiation Overlap shear analysis measurement was performed after 24 hours. The resin left behind in the cup remained uncured at the time of analysis as determined by the ability to stir the material easily with a wooden stick without noticing any cured sections. The results of the overlap shear analysis are reported in Table 10.

TABLE 9

| | BASE | ACCELERATOR | | |
|---|---|---|---|---|
| | FORMULATION | FORMULATION | PHOTOINITIATOR | |
| | PE1-B | PE2-C | OM184 | BEADS |
| EXAMPLE | grams | | | |
| CE7 | 5.0 | 0.5 | | 0.001 |
| EX5 | 5.0 | 0.5 | 0.027 | 0.001 |
| EX6 | 5.0 | 0.5 | 0.055 | 0.001 |
| CE8 | 5.0 | | 0.050 | 0.001 |

TABLE 10

| | | NUMBER | | | |
|---|---|---|---|---|---|
| | | OF | AVERAGE | STANDARD | |
| | | SPECIMENS | STRENGTH, | DEVIATION, | |
| EXAMPLE | SUBSTRATE | TESTED | kPa | kPa | NOTES |
| CE7 | aluminum | 4 | 6020 | 1027 | |
| EX5 | aluminum | 4 | 7357 | 1310 | |
| EX6 | aluminum | 4 | 8529 | 1503 | |
| CE8 | aluminum | 4 | 1427 | 1089 | |
| CE7 | nylon | 4 | 2082 | 434 | |
| EX5 | nylon | 4 | 2227 | 248 | |
| EX6 | nylon | 4 | 2558 | 200 | |
| CE8 | nylon | 1 | 21 | 0 | 3 substrates |
| | | | | | broke before |
| | | | | | analysis |

### Example EX7 and Comparative Example CE9

Example EX7 and Comparative Example CE9 were prepared for IR analysis by mixing TS720 with inkjet printable pressure-sensitive adhesive compositions from Preparative Example 3 according to the General Procedure for FTIR Specimen Sandwich Construction. Two sandwich specimens were made for each Example. The compositions of Examples EX7 and Comparative Example CE9 are reported in Table 11, below.

TABLE 11

| | PE3-A | PE3-B | TS720 |
|---|---|---|---|
| EXAMPLE | grams | | |
| CE9 | 2.5 | | 0.15 |
| EX7 | | 2.5 | 0.15 |

The FTIR specimen sandwiches for EX7 and CE9 were analyzed according to the General Procedure for Cure Monitoring by FTIR (Series). Series data was collected for 3 or 5 minutes prior to UV irradiation. At the 3-minute or 5-minute mark, a 5-second or 15-second irradiation from the LX400 light source was applied according to the General Procedure for Irradiation in the FTIR Spectrometer. The results are reported in Tables 12 and 13.

TABLE 12

| IRRADIATION TIME, | CE9 | EX7 |
|---|---|---|
| seconds | 5 | 5 |
| % CONVERSION AT | 0 | 0 |
| T = 0 MIN | | |
| % CONVERSION AT | 3 | 0 |
| T = 3 MIN | | |
| % CONVERSION AT | 91 | 90 |
| T = 3.74 MIN | | |
| % CONVERSION AT | 92 | 94 |
| T = 15 MIN | | |
| % CONVERSION AT | 92 | 95 |
| T = 20 MIN | | |

TABLE 13

| IRRADIATION TIME, | CE9 | EX7 |
|---|---|---|
| seconds | 15 | 15 |
| % CONVERSION AT | 0 | 0 |
| T = 0 MIN | | |
| % CONVERSION AT | 0 | 0 |
| T = 5 MIN | | |
| % CONVERSION AT | 97 | 97 |
| T = 6.05 MIN | | |
| % CONVERSION AT | 98 | 99 |
| T = 15 MIN | | |
| % CONVERSION AT | 98 | 100 |
| T = 35 MIN | | |

### Examples EX8 to EX9 and Comparative Example CE10

For Examples EX8 to EX9 and Comparative Example CE10, pressure-sensitive adhesive tapes were produced using the following procedure. The particular liquid adhesive formulations, conveyor speeds, and irradiation doses utilized for the Examples are reported in Table 14. In each case, the liquid adhesive formulation was coated onto 3SAB liner at a thickness of approximately 75 microns by using a wire-wound metal rod (BYK Instruments). The tape was then irradiated using an Omnicure AC475 365 nm LED at 99.5% power (1350 mW/cm², Lumen Dynamics, Mississauga, Ontario, Canada) set over a variable-speed conveyor. For non-aged specimens, the tape was slit and used immediately for 180° peel adhesion and static shear measurements. For aged specimens, the adhesive film was laminated with RFO2N and aged at room temperature for 18 hours before testing. The non-aged and aged specimens were subjected to static shear and 180° peel adhesion tests as described hereinabove. The results of this testing are reported in Tables 15 and Table 16.

TABLE 14

| | | CONVEYOR | TOTAL |
|---|---|---|---|
| | LIQUID | SPEED, | IRRADIATION |
| EXAMPLE | FORMULATION | m/min | DOSE, mJ/cm² |
| CE10 | PE3-A | 1.5 | 840 |
| EX8 | PE3-B | 1.5 | 840 |
| EX9 | PE3-C | 0.6 | 2250 |

TABLE 15

| | STATIC SHEAR TEST RESULTS | | | |
|---|---|---|---|---|
| | NON-AGED SPECIMENS | | AGED SPECIMENS | |
| | SHEAR | | SHEAR | |
| | TIME, | FAILURE | TIME, | FAILURE |
| EXAMPLE | minutes | MODE | minutes | MODE |
| CE10 | 2 | Cohesive/monomer | 8 | Cohesive |
| | | residue | | |
| EX8 | 1 | Cohesive/monomer | >10000 | N/A |
| | | residue | | |
| EX9 | 0 | Cohesive/monomer | >10000 | N/A |
| | | residue | | |

TABLE 16

| | 180° PEEL ADHESION | | | |
|---|---|---|---|---|
| | NON-AGED SPECIMENS | | AGED SPECIMENS | |
| | PEEL STRENGTH, | | PEEL STRENGTH, | |
| EXAMPLE | oz/in (mN/cm) | FAILURE MODE | oz/in (mN/cm) | FAILURE MODE |
| CE10 | 0.14 (15) | cohesive/monomer | 1.46 (160) | cohesive |
| | | residue | | |
| EX8 | 0.19 (21) | cohesive/monomer | 6.86 (751) | clean peel |
| | | residue | | |
| EX9 | 0.33 (36) | cohesive/monomer | 6.28 (687) | clean peel |
| | | residue | | |

For gravimetric residual testing, the liquid formulations of EX8, EX9, and CE10 were applied by pipette to aluminum weigh pans, then cured using a 365 nm LED cure wand (Thor Labs) at a distance of 1 inch (2.5 cm) with a power of 100% for 30 seconds. The specimens were then covered with release liner and aged for 18 hours before the remainder of residuals testing. Following this, the specimens were tested according to the general Gravimetric Residual Test Method. The results are reported in Table 17, below.

TABLE 17

| | LIQUID | GRAVIMETRIC |
|---|---|---|
| EXAMPLE | FORMULATION | RESIDUALS, % |
| CE10 | PE3-A | 8.2 |
| EX8 | PE3-B | 6.3 |
| EX9 | PE3-C | 13.6 |

### Examples EX10 to EX11 and Comparative Examples CE11 to CE12

Four redox-agent-containing premixtures were made by the following procedure and the compositions shown in Table 18. Compositions were combined in glass jars and shaken overnight at room temperature on a KS501 digital lab shaker (IKA-Werke, Germany) to dissolve.

TABLE 18

| | | COPPER | | | | |
|---|---|---|---|---|---|---|
| | | ACETATE | | | ACRYLIC | |
| | AminHCl | MONOHYDRATE | PIPAA | bPHDMBA | ACID | DMAA |
| PREMIXTURE | Parts by weight | | | | | |
| PM1 | 9.1 | | | | 90.9 | |
| PM2 | | 0.05 | | | 99.95 | |
| PM3 | | | 10.7 | | | 89.3 |
| PM4 | | | | 9.1 | 90.9 | |

Acrylic syrups were prepared as described in EP2803712A1. The acrylic syrup was prepared by initially pre-polymerizing acrylic acid and EHA in a vessel containing 0.04 pph OM651 by exposing to ultraviolet radiation until a coatable syrup with a viscosity of about 11000 mPa·s (when measured with a Brookfield viscosimeter T=25° C., spindle 4, 12 revolutions per minute (rpm)) was obtained. Before the UV-exposure, the mixture was flushed 10 minutes with nitrogen and nitrogen was also bubbled to the mixture until the polymerization process was stopped by adding air to the syrup. All the time the mixture was stirred with a propeller stirrer (300 rpm) and the reaction was stopped when a viscosity of about 11000 mPa·s was reached. Then, additional co-monomer(s), the remaining photoinitiator, and redox premixtures are added to the syrup according to the amounts listed in Table 19. These syrups were homogenized by rolling at 35 rpm for 2 hours on a LABINCO LD209750 Rolling Bench jar roller (LABINCO, Breda, Netherlands). The resulting syrups were coated between two transparent silicone-treated release liners on a knife coater at a gap of 1 mm.

TABLE 19

| | ACRYLIC | | | | | | | | | |
|---|---|---|---|---|---|---|---|---|---|---|
| | ACID | EHA | OM651 | HDDA | DMAA | PM1 | PM2 | PM3 | PM4 | TAH85 |
| EXAMPLE | Parts by weight | | | | | | | | | |
| CE11 | 9.97 | 89.71 | 0.24 | 0.10 | 5.01 | | | | | |
| EX10 | 9.97 | 89.70 | 0.24 | 0.10 | | 0.10 | 0.10 | 5.60 | | 0.83 |
| CE12 | 9.97 | 89.89 | 0.24 | 0.10 | | | | | | |
| EX11 | 9.97 | 89.72 | 0.24 | 0.10 | | 0.10 | 0.10 | | 7.50 | 0.83 |

A custom-made UV curing station was used to irradiate the coated syrups. The maximum irradiance of the curing station was 0.2 mW/cm² at a wavelength of 340 nm at 100% lamp intensity. Mercury lamps from the top and the bottom were used to irradiate the syrups for 5 minutes at different intensity levels according to Table 20. The temperature of the surface of the resulting tape was determined using an Infrared Thermometer 1327K (RS Pro, Fort Worth, Texas, USA) immediately after irradiation on the UV curing station. The results of this testing are reported in Table 20 (below).

TABLE 20

| EXAMPLE | TEMPERATURE, ° C. | LAMP INTENSITY, % |
|---|---|---|
| CE11 | 61 | 60 |
| EX10 | 69 | 60 |
| CE12 | 55 | 90 |
| EX11 | 69 | 90 |

The preceding description, given in order to enable one of ordinary skill in the art to practice the claimed disclosure, is not to be construed as limiting the scope of the disclosure, which is defined by the claims and all equivalents thereto.

1. A photopolymerizable composition comprising:
at least one free-radically polymerizable compound;
at least one organic photoactivatable reducing agent precursor;
at least one reducible transition metal compound comprising at least one of cobalt, copper, iron, manganese, nickel, or vanadium;
at least one organic peroxide; and
at least one photoinitiator, wherein the at least one photoinitiator does not comprise an organic peroxide.

2. The photopolymerizable composition of claim 1, wherein the at least one organic photoactivatable reducing agent precursor comprises at least one of 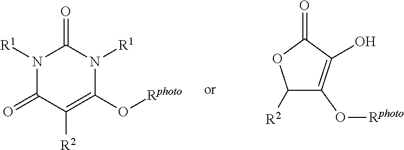
wherein each R¹ independently represents a hydrocarbyl group having from 1 to 18 carbon atoms, R² represents a monovalent organic group having from 1 to 18 carbon atoms, and R^{photo} represents a photoremovable group.

3. The photopolymerizable composition of claim 1, wherein the at least one organic photoactivatable reducing agent precursor comprises at least one compound represented by the formula

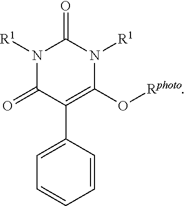

4. The photopolymerizable composition of claim 1, wherein the at least one organic photoactivatable reducing agent precursor comprises at least one compound represented by the formula

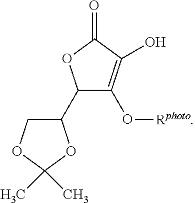

5. The photopolymerizable composition of claim 1, wherein R^{photo} represents an ortho-nitrobenzyl group.

6. The photopolymerizable composition of claim 1, wherein the at least one free-radically polymerizable compound comprises at least one compound comprising at least one (meth)acryl group.

7. The photopolymerizable composition of claim 1, wherein the at least one photoinitiator comprises a Type I photoinitiator.

8. The photopolymerizable composition of claim 7, wherein the at least one Type I photoinitiator is selected from the group consisting of selected from the group consisting of benzoin ethers, benzyl ketals, α,α-dialkoxyacetophenones, α-hydroxyalkylphenones, α-dialkylaminoalkylphenones, acylphosphine oxides, acylphosphines, substituted derivatives thereof, and combinations thereof.

9. The photopolymerizable composition of claim 1, wherein the at least one photoinitiator comprises a Type II photoinitiator.

10. The photopolymerizable composition of claim 9, wherein the at least one Type II photoinitiator comprises benzophenone, camphorquinone, or a substituted benzophenone.

11. The photopolymerizable composition of claim 1, wherein the at least one reducible transition metal compound comprises at least one of copper 2-ethyl hexanoate, copper acetate, copper benzoylacetone, copper 1-phenylpentane-1,3-dione, copper acetylacetonate, or copper naphthenate.

12. The photopolymerizable composition of claim 1, further comprising at least one tertiary or quaternary ammonium salt.

13. The photopolymerizable composition of claim 12, wherein the at least one tertiary or quaternary ammonium salt is represented by the formula R⁴ N⁺X⁻, wherein each R independently represents a hydrocarbyl group having from 1 to 18 carbon atoms and X represents F, Cl, Br, or I.

14. The photopolymerizable composition of claim 12, wherein the at least one tertiary or quaternary ammonium salt is represented by the formula R³ NH⁺X⁻, wherein each R independently represents a hydrocarbyl group having from 1 to 18 carbon atoms and X represents F, Cl, Br, or I.

15. The photopolymerizable composition of claim 1, wherein the photopolymerizable composition is divided into a Part A portion and a Part B portion, and wherein none of the at least one reducible transition metal compound is present in Part A, and wherein none of the at least one organic peroxide is present in Part B.

16. The photopolymerizable composition of claim 1, wherein the photopolymerizable composition is divided into a Part A portion and a Part B portion, and wherein none of the at least one tertiary or quaternary ammonium salt is present in Part A, and wherein none of the at least one organic peroxide is present in Part B.

17. A method of bonding first and second substrates, the method comprising contacting the photopolymerizable composition of claim 1 with at least one of the first and second substrates and exposing at least a portion of the photopolymerizable composition to actinic radiation sufficient to cause at least partial curing of the photopolymerizable composition.

18. (canceled)

19. A method of sealing a substrate, the method comprising contacting the photopolymerizable composition of claim 1 with the substrate, exposing the photopolymerizable composition to actinic radiation, and at least partially curing the photopolymerizable composition.

20. An at least partially polymerized composition comprising an at least partially cured photopolymerizable composition according to claim 1.

21. The at least partially polymerized composition of claim 20, wherein the at least partially polymerized composition is a pressure sensitive adhesive at 25° C.
